(19) United States
(12) Patent Application Publication
(10) Pub. No.: US 2025/0270975 A1
(43) Pub. Date: Aug. 28, 2025

(54) SYSTEM FOR SELECTIVE INTAKE AIR HEATING

(71) Applicant: FCA US LLC, Auburn Hills, MI (US)

(72) Inventors: Sreekanth Surapaneni, Oakland, MI (US); Uday Kiran Mahakali, Novi, MI (US)

(21) Appl. No.: 18/588,071

(22) Filed: Feb. 27, 2024

(51) Int. Cl. F02M 35/10; B60K 13/02; B60K 13/06; F02M 35/02; F02M 35/024

(52) U.S. Cl. CPC F02M 35/1038; B60K 13/02; B60K 13/06; F02M 35/0209; F02M 35/02416; F02M 35/10268

(57) ABSTRACT

A vehicle system, includes an air intake assembly, a heat source, a valve, a temperature indicator and a controller. The air intake assembly including an inlet through which air flows, a filter downstream of the inlet, and an outlet downstream of the filter through which air from the filter flows. The valve is electrically actuated and arranged to selectively permit air flow from the heat source to the inlet. The temperature indicator provides an indication of a temperature in the air intake assembly upstream of the filter. And the controller is communicated with the temperature indicator and the valve and operable to open the valve when the output of the temperature indicator indicates a temperature below a temperature threshold.

### FIELD

The present disclosure relates to a system for selectively heating air inducted into an engine air intake.

### BACKGROUND

Vehicles include an air intake through which air is routed to an engine to support combustion in the engine. In cold weather, snow can be taken into or ice may develop within the air intake. The snow or ice can block or otherwise impeded air flow through the air intake assembly and reduce air flow to the engine which negatively impacts engine performance.

### SUMMARY

In at least some implementations, a vehicle system, includes an air intake assembly, a heat source, a valve, a temperature indicator and a controller. The air intake assembly including an inlet through which air flows, a filter downstream of the inlet, and an outlet downstream of the filter through which air from the filter flows. The valve is electrically actuated and arranged to selectively permit air flow from the heat source to the inlet. The temperature indicator provides an indication of a temperature in the air intake assembly upstream of the filter. And the controller is communicated with the temperature indicator and the valve and operable to open the valve when the output of the temperature indicator indicates a temperature below a temperature threshold.

In at least some implementations, the valve is closed when the temperature in the air intake assembly upstream of the filter is above the temperature threshold.

In at least some implementations, the heat source is a heat exchanger associated with an engine of the vehicle. In at least some implementations, the heat exchanger is an air-to-liquid heat exchanger through which coolant for an engine is routed.

In at least some implementations, the heat source is a compressor of a turbocharger.

In at least some implementations, the heat source is an area outboard of an engine in an engine compartment of the vehicle that is heated by operation of the engine. In at least some implementations, a fan is arranged to move air in a conduit and toward the valve.

In at least some implementations, the valve has a valve head received in a conduit arranged between the heat source and the inlet, and the valve head is rotatable between a closed position and an open position. In at least some implementations, the valve has an intermediate position between the closed position and the open position. In at least some implementations, a fan provided between the heat source and the valve and arranged to move air in the conduit toward the valve.

In at least some implementations, the temperature indicator is responsive to a temperature between the inlet and the filter within a housing of the air intake assembly.

In at least some implementations, a method of selectively increasing the temperature within an air intake for an engine includes determining a temperature; comparing the temperature to a temperature threshold, and providing air flow from a heat source to an intake duct of an air intake assembly when the temperature does not satisfy the temperature threshold.

In at least some implementations, providing air flow is accomplished by opening a valve to permit air flow through the valve to the intake duct. In at least some implementations, the valve includes a solenoid, and the valve is opened by providing electricity to the valve and the valve is located at least partly in a conduit between the heat source and the intake duct.

In at least some implementations, the air flow is provided for a predetermined period of time. In at least some implementations, the period of time varies as a function of the magnitude of a difference between the temperature and the temperature threshold.

In at least some implementations, the temperature is redetermined one or more times and terminating the air flow when the temperature is determined to be above a second temperature which may be equal to or greater than the temperature threshold.

In at least some implementations, the heat source is a heat exchanger of the vehicle.

In at least some implementations, the heat source is an engine of the vehicle or a turbocharger of the vehicle.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a diagrammatic view of a vehicle including an engine and an air intake system via which air is supplied to the engine;

FIG. 2 is a diagrammatic view of a system for selectively providing heated air to the air intake assembly;

FIG. 3 is a schematic view of a system for selectively increasing the temperature within an intake duct of an air intake assembly for a vehicle;

FIG. 4 is a plan view of a portion of a vehicle engine

compartment;

FIG. 5 is a schematic view of a system for selectively increasing the temperature within an intake duct of an air intake assembly for a vehicle;

FIG. 6 is a plan view of a portion of a vehicle engine compartment; and

FIG. 7 is a flowchart of a method for selectively increasing the

temperature within an intake duct of an air intake assembly.

### DETAILED DESCRIPTION

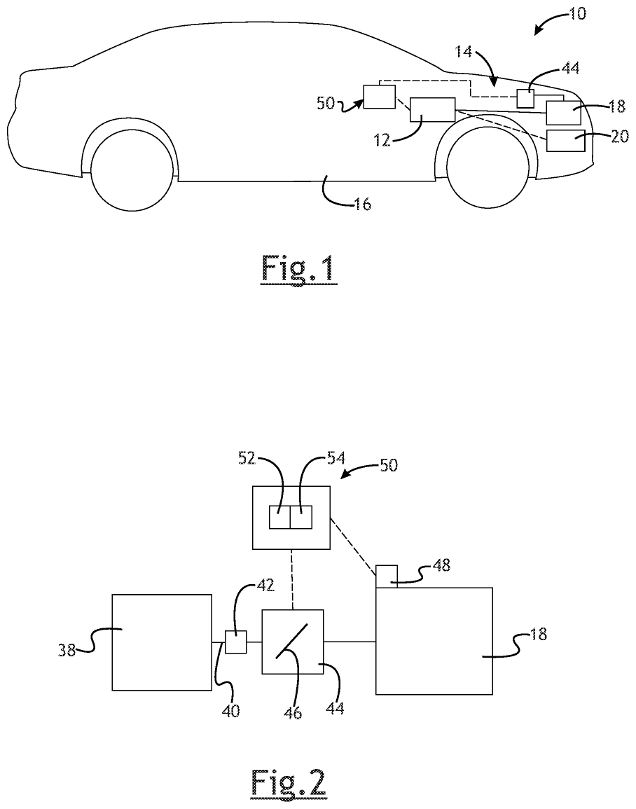

Referring in more detail to the drawings, FIG. 1 illustrates a vehicle 10 having a combustion engine 12 in an engine compartment 14 of the vehicle body 16. In the engine 12, a mixture of air and fuel is ignited to generative motive power for the vehicle 10. Fuel may be provided to the engine 12 by one or more fuel injectors and air may be routed to the engine 12 via an air intake assembly 18. Engine coolant is circulated relative to the engine 12 and through a heat exchanger or radiator 20. The radiator 20 is a liquid-to-air heat exchanger by which heat in the coolant is conducted to the metal housing of the radiator 20, and the heat is radiated and transferred by convection to air surrounding the radiator 20 within the engine compartment 14. This reduces the temperature of the coolant flowing therethrough and increases the temperature of the surrounding air.

As shown in FIG. 4, the air intake assembly 18 may include a housing 22 received in the engine compartment 14 and having an inlet 24 through which air flows into the housing 22. The inlet 24 may be a port oriented to receive air flowing from the front of the vehicle 10 toward the rear of the vehicle 10. Air that enters the inlet 24 flows through an intake chamber or duct 26 to a filter 28 located within the housing 22, downstream of the inlet 24. The filter 28 removes contaminants from the air flow, and in use, a flow of filtered air exits the filter 28 and is directed by a clean air chamber or clean air duct 30 to an outlet 32 of the air intake assembly 18 from which filtered air exits the housing 22. Air that exits the housing 22 is routed to the engine 12 to support combustion in the engine 12.

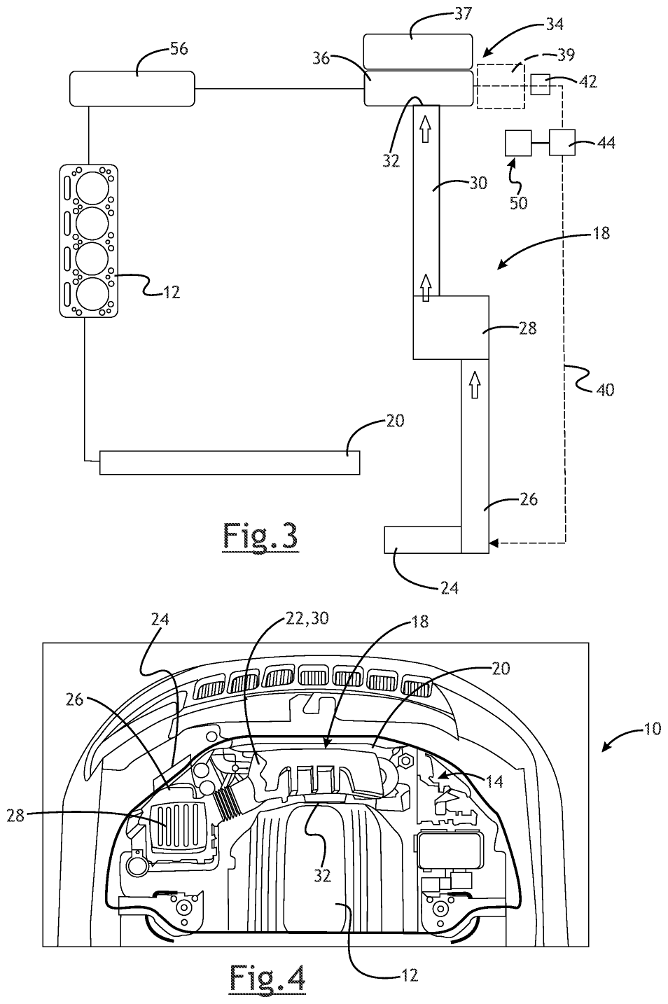

In at least some implementations, such as is shown in FIG. 3, the vehicle 10 includes a turbocharger 34 arranged between the outlet 32 of the air intake assembly 18 and the engine 12. The turbocharger 34 includes a compressor 36 arranged to discharge air at an increased pressure and provided an increased mass flow rate of air to the engine 12. The compressor 36 may be coupled to a turbine 37 that is driven, for example, by a flow of exhaust gas from the engine 12.

In cold weather, ice can form and snow can enter the inlet 24 of the air intake housing 22. The ice and snow can restrict air flow to the filter 28 and thus, to the engine 12, and this can starve the engine 12 of air and decrease engine performance. To inhibit or prevent ice formation, or to melt any ice or snow in the air intake assembly 18, the vehicle 10 includes a system to provide heated air into the air intake assembly 18.

In at least some implementations, as shown in FIG. 2, the system includes a heat source 38 that gives off heat to air near the heat source 38, and a conduit 40 communicated with the heat source 38 or air heated thereby, and with the inlet 24 of the air intake housing 22 and via which air may be routed to the interior of the air intake housing 22, upstream of the filter 28. In use of the vehicle 10, air is heated by one or more components of the vehicle, such as heat exchangers (e.g. radiator 20 or other heat exchanger), or the engine 12 or the turbocharger 34, for example, the compressor 36 thereof, and these components may be considered to be heat sources as can areas near these devices that include the air heated by them.

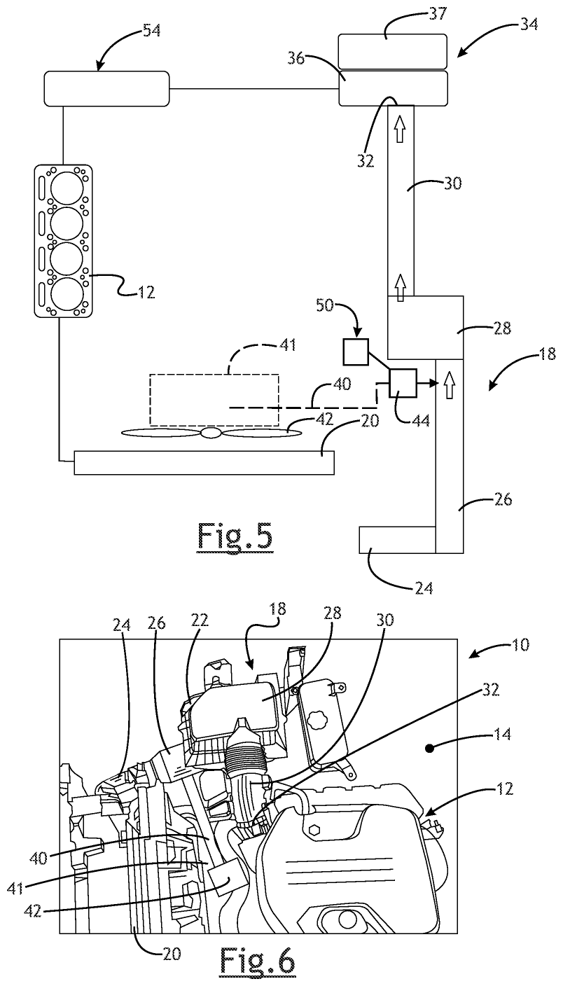

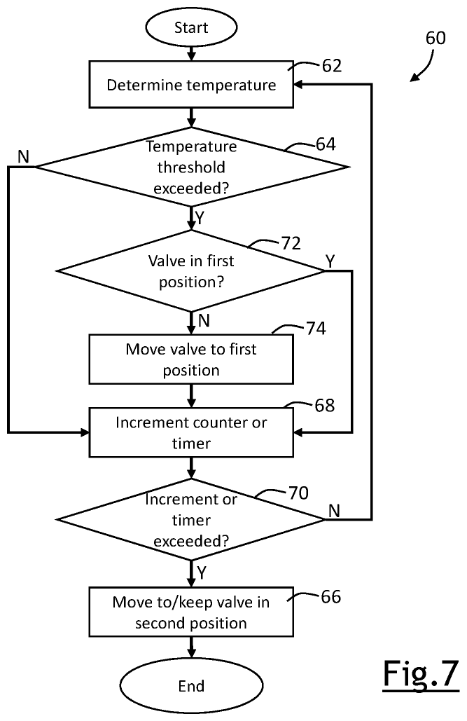

In the implementation shown in FIGS. 3 and 4, compressor 36 and/or area 39 near compressor 36 is a heat source, and heated air may be routed therefrom to the intake duct 26 through the valve 44, with or without a fan 42 providing a forced air flow. In the implementation shown in FIGS. 5 and 6, area 41 near engine 12 is a heat source and a fan 42 may be used to force air flow to the intake duct 26 in the conduit 40. The fan 42 could be a stand alone or dedicated fan, or it may be a fan associated with the radiator 20 or other heat exchanger, or other component in the engine compartment 14.

In use, these components or areas often have a temperature above the ambient temperature and heat given off from these components can then be used to increase the temperature within the intake duct 26 of the air intake housing 22. This temperature increase can inhibit or prevent ice or snow from developing or accumulating within the intake duct 26 of the air intake housing 22 to reduce or eliminate air flow restriction that would otherwise occur from such snow or ice. As used herein, the term “conduit” is intended to mean a component or components that include a void, chamber or passage or other structure(s) by which air may be routed.

In at least some implementations, a forced air source, like a fan 42, may provide a forced air flow through the conduit 40 and to the intake duct 26. In some implementations, with or without a forced air flow from a fan or the like, air may flow through the conduit 40 due to a pressure difference wherein the pressure in the intake duct 26 is lower due to air flow through the intake duct 26 during engine operation or otherwise, or due to a temperature difference causing such air flow.

In at least some implementations, air through the conduit 40 and to the intake duct 26 of the air intake housing 22 is provided only some of the time and not continually. In such implementations, a valve 44 may be provided to selectively permit and prevent, or at least significantly inhibit, air flow from the conduit 40 and into the air intake housing 22. The valve 44 may be electrically actuated, such as by including or being driven by a solenoid, to move between a first position and a second position, in which a greater flow or air is permitted than when the valve 44 is in the first position. The valve 44 may be a butterfly valve with a disc-shaped valve head 46 received within the conduit 40, and in the first position the valve head 46 may mostly or fully block the flow area of the conduit 40 to inhibit or prevent air flow therethrough. In the second position, the valve head 46 is rotated relative to the first position and a greater effective flow area is provided between the valve head 46 and the conduit 40 than when the valve head 46 is in the first position. Flow area, as used herein, is a cross-sectional area through which air may flow within the conduit 40 and around the valve head 46. In the first position, the valve head 46 may reduce the effective flow area of the conduit 40 by 90% or more, including up to 100%, in at least some implementations. While described with regard to one embodiment as a butterfly valve, the valve 44 may be of any desired construction and shape suitable to control air flow through the conduit 40 as noted herein. In at least some implementations, the valve 44 may also have one or more intermediate positions between the first and second/opened and closed positions, to throttle or otherwise control air flow as desired.

In at least some implementations, the valve 44 is controlled in response to a temperature, which may be determine by a temperature sensor 48, and the valve 44 may be opened when the temperature is below a temperature threshold, and the valve 44 may be closed when the temperature is above the temperature threshold. The temperature threshold may be set with regard to a temperature at or below which ice or snow may be likely to form at or near the air intake housing 22. The temperature may be an ambient temperature (e.g. temperature outside the vehicle 10), or a temperature at or near the air intake housing 22, which may include within the intake duct 26 of the air intake housing 22. In this regard, the temperature sensor 48 may be a sensor used to provide an indication of ambient temperature within the vehicle 10, such as via an infotainment system of the vehicle 10, may be obtained from a weather information source (e.g. via a telematics unit of the vehicle 10), may be a temperature sensor 48 used by other vehicle systems (e.g. to sense the temperature of part of the engine 12 or engine oil temperature) or may be a dedicated temperature sensor used for the purpose of controlling the valve 44. For example, a temperature sensor 48 may be mounted to the housing 22 and may have a portion exposed to air within the intake duct 26 or otherwise be arranged to be responsive to the temperature within the intake duct 26. The temperature sensor 48 may provide an output indicative of the temperature within the intake duct 26, which may be a direct measurement or determination of that temperature or which may be inferred from other temperatures and or time or other information relating to use of the vehicle 10.

To control the valve 44, the system includes a control system 50 with a controller 52 that is communicated with the temperature sensor 48 and with the valve 44. The controller 52 is operable to open the valve 44 when the output of the temperature sensor 48 indicates a temperature below a temperature threshold, and to close, or permit the valve 44 to move to the closed position such as under the force of a biasing member like a spring, when the temperature is at or above the temperature threshold. In the example wherein the valve 44 includes a solenoid, the controller 52 may selectively provide electricity to the valve 44 to selectively drive the valve 44 and change the position of the valve 44.

In at least some implementations, it may be desirable to provide heated air to the intake duct 26 to increase the temperature within the intake duct 26 only in conditions in which snow or ice may exist within the intake duct 26. In other instances, it might not be desirable to increase the temperature of the air in the intake duct 26 because air at higher temperatures is less dense and leads to reduce engine output. For this reason, the vehicle 10 may include a heat exchanger 56 (e.g. an intercooler or charge air cooler), which may be an air-to-air or liquid-to-air (e.g. liquid coolant or water) heat exchanger, arranged to reduce the temperature of air delivered into the engine 12 for combustion. Thus, in general, it may be desirable to provide colder air to the engine 12 and so, in at least some implementations, heating the intake duct 26 may be limited to conditions in which snow or ice may be present within the intake duct 26, and to otherwise avoid increasing the temperature within the intake duct 26. In at least some implementations, the threshold temperature is between 32 degrees Fahrenheit and 36 degrees Fahrenheit.

In order to perform the functions and desired processing set forth herein, as well as the computations therefore, the control system 50 may include, but is not limited to, one or more controller(s), processor(s), computer(s), DSP(s), memory, storage, register(s), timing, interrupt(s), communication interface(s), and input/output signal interfaces, and the like, referred to be reference numeral 52 in FIG. 2, as well as combinations comprising at least one of the foregoing. For example, the control system 50 may include input signal processing and filtering to enable accurate sampling and conversion or acquisitions of such signals from communications interfaces and sensors. As used herein the terms control system 50 may refer to one or more processing circuits such as an application specific integrated circuit (ASIC), an electronic circuit, a processor (shared, dedicated, or group) and memory that executes one or more software or firmware programs, a combinational logic circuit, and/or other suitable components that provide the described functionality. The control system 50 may be distributed among different vehicle modules, such as an infotainment control module, engine control module or unit, powertrain control module, transmission control module, and the like, if desired.

The term “memory” or “storage” as used herein can include volatile memory and/or non-volatile memory, generally referred to by reference numeral 54 in FIG. 2. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system that controls or allocates resources of a computing device.

FIG. 7 illustrates a method 60 of controlling temperature within an air intake assembly 18 of a vehicle 10. The method 60 may be run after the vehicle 10 is turned on (e.g. keyed on, or engine started, or the like) and in step 62, a temperature is determined. The temperature may be determined from information from any suitable temperature indicator, which may be a source of temperature data within or remotely located from the vehicle 10, or a temperature sensor 48 of the vehicle 10, for example.

Next, in step 64, the determined temperature is compared to a threshold temperature. If the determined temperature is not less than the threshold temperature, then the method 60 ensure that the valve 44 is in the second position, inhibiting or preventing air flow from the heated air source to the air intake assembly 18, and if not, the method 60 may skip to step 66 and cause the valve 44 to move to the second position (or remain in the second position if the valve is already in the second position) and then the method 60 may end. If a dedicated fan 42 is provided to cause a forced air flow to the intake duct 26, then this step may also include turning off the fan or ensuring that the fan remains off, so that the fan is used only when the valve 44 is open.

If desired, instead of ending after one iteration, the method 60 may loop back to step 62 one or more times to check or determine the temperature again and compare again the newly determined temperature to the threshold temperature in step 64. A counter may be used and incremented in step 68 each time the determined temperature is not less than the threshold temperature and the method 60 may end after the counter reaches a desired number as checked in step 70. In at least some implementations, the counter value needed to terminate the method 60 may be set as a function of the difference between the determined temperature and the threshold temperature with a greater differential requiring fewer iterations (down to one iteration), as the confidence that snow or ice conditions are not present is greater when the determined temperature is higher.

If in step 64 the determined temperature is less than the threshold temperature, then the method 60 continues to step 72 in which it is determined if the valve 44 is in the first position in which greater air flow is permitted by the valve 44. If the valve 44 is not in the first position, then the method 60 proceeds to step 74 in which the valve 44 is moved to the first position (e.g. opened) to permit air flow, or an increased air flow, from the heated air source to the air intake assembly 18. If a dedicated fan 42 is used, this step may also include turning on the fan 42 to provide a forced air flow so that the fan is operated only when the valve 44 is open, if desired. In the example wherein the temperature determination is based on the output from a temperature sensor 48 that is responsive to the instantaneous or current temperature within the air intake assembly 18 (e.g. within the intake duct 26) then the method 60 may loop back to step 62, perhaps after expiration of a time period determined by a timer associated with the controller 52 to allow some time for the temperature in the air intake assembly 18 to increase or with use of a counter as noted above. This new, updated or more current temperature determination is then compared to the threshold temperature in step 64 or to a second temperature which may be a set value or a variable threshold, and which may be the same as or different than the original or first temperature threshold.

In other example methods, the system may assume a temperature increase in the air intake assembly 18 occurs after a certain amount of time after the engine 12 has been operating, and after this time, the method 60 may move the valve 44 to the second position and then end. This assumption of temperature increase may be made based on empirical data taken over time and related to the temperature within the engine compartment 14 of the vehicle 10 as a function of operation of the engine 12, engine oil temperature or other engine temperature, or the like, which may be mapped or otherwise determined as a function of or independently of an ambient temperature. The time period may be varied based upon the difference between the determined temperature and the threshold temperature, with a greater time period provided when the determined temperature is lower.

For example, if the determined temperature is ten degrees Fahrenheit below the threshold temperature, then the method 60 may cause the valve 44 to be opened (in the first position) for a predetermined time period deemed sufficient to ensure that the temperature within the intake duct 26 increases at least ten degrees before the valve 44 is closed (moved to the second position). In this example, when the determined temperature is five degrees Fahrenheit below the threshold temperature, the time period might be less. In this way, further iterations of redetermining the temperature and comparing the redetermined temperature to the threshold temperature are not needed. This may facilitate use of ambient temperature such as may be determined by a temperature sensor 48 of the vehicle 10 or a remote temperature/weather data source, or an engine temperature, to conveniently be used to determine when the valve 44 should be opened so that a dedicated temperature sensor is not needed for the air intake assembly 18 in some implementations.

The systems and method herein can, among other things, prevent or inhibit or reduce ice or snow within the intake duct of the air intake assembly to improve air flow through the assembly and to the engine. The system may intelligently control air flow to the air intake assembly to provide heated air when needed and avoid unduly heating air when heated air is not needed within the air intake assembly.

1. A vehicle system, comprising:
an air intake assembly including an inlet through which air flows, a filter downstream of the inlet, and an outlet downstream of the filter through which air from the filter flows;
a heat source;
a valve that is electrically actuated and arranged to selectively permit air flow from the heat source to the inlet;
a temperature indicator providing an indication of a temperature in the air intake assembly upstream of the filter; and
a controller communicated with the temperature indicator and the valve and operable to open the valve when the output of the temperature indicator indicates a temperature below a temperature threshold.

2. The system of claim 1 wherein the valve is closed when the temperature in the air intake assembly upstream of the filter is above the temperature threshold.

3. The system of claim 1 wherein the heat source is a heat exchanger associated with an engine of the vehicle.

4. The system of claim 3 wherein the heat exchanger is an air-to-liquid heat exchanger through which coolant for an engine is routed.

5. The system of claim 1 wherein the heat source is a compressor of a turbocharger.

6. The system of claim 1 wherein the heat source is an area outboard of an engine in an engine compartment of the vehicle that is heated by operation of the engine.

7. The system of claim 6 which also includes a fan arranged to move air in a conduit and toward the valve.

8. The system of claim 1 wherein the valve has a valve head received in a conduit arranged between the heat source and the inlet, and the valve head is rotatable between a closed position and an open position.

9. The system of claim 8 wherein the valve has an intermediate position between the closed position and the open position.

10. The system of claim 8 which also includes a fan provided between the heat source and the valve and arranged to move air in the conduit toward the valve.

11. The system of claim 1 wherein the temperature indicator is responsive to a temperature between the inlet and the filter within a housing of the air intake assembly.

12. A method of selectively increasing the temperature within an air intake for an engine, comprising:
determining a temperature;
comparing the temperature to a temperature threshold;
providing air flow from a heat source to an intake duct of an air intake assembly by opening a valve to permit air flow through the valve to the intake duct when the temperature does not satisfy the temperature threshold; and
preventing air flow from the heat source to the intake duct of the intake assembly by closing a valve to prevent air flow through the valve to the intake duct when the temperature satisfies the temperature threshold.

13. The method of claim 12 wherein providing air flow is accomplished by opening a valve to permit air flow through the valve to the intake duct.

14. The method of claim 13 wherein the valve includes a solenoid, and the valve is opened by providing electricity to the valve and the valve is located at least partly in a conduit between the heat source and the intake duct.

15. The method of claim 12 wherein the air flow is provided for a predetermined period of time.

16. The method of claim 15 wherein the period of time varies as a function of the magnitude of a difference between the temperature and the temperature threshold.

17. The method of claim 12 which also includes redetermining the temperature one or more times and terminating the air flow when the temperature is determined to be above a second temperature which may be equal to or greater than the temperature threshold.

18. The method of claim 12 wherein the heat source is a heat exchanger of the vehicle.

19. The method of claim 12 wherein the heat source is an engine of the vehicle or a turbocharger of the vehicle.
